(19) United States
(12) Patent Application Publication
(10) Pub. No.: US 2024/0289419 A1
(43) Pub. Date: Aug. 29, 2024

(54) CONFIGURABLE AI-ASSISTED COMPUTE FABRIC

(71) Applicant: Areanna Inc., San Carlos, CA (US)

(72) Inventors: Ronald E. Gagnon, JR., Berkeley, CA (US); Charles Prince Buchbinder, San Carlos, CA (US); Jorge A. Grilo, Berkeley, CA (US); Behdad Youssefi, Berkeley, CA (US)

(21) Appl. No.: 18/590,823

(22) Filed: Feb. 28, 2024

Related U.S. Application Data
(60) Provisional application No. 63/449,032, filed on Feb. 28, 2023.

(51) Int. Cl. G06F 17/16

(52) U.S. Cl. CPC G06F 17/16

(57) ABSTRACT

A compute fabric includes, in part: a multitude of compute tiles disposed in a memory block, a networking circuit coupled to the compute tiles and adapted to enable communication between the compute tiles and further to enable the compute tiles to communicate with a system external to the compute fabric; and controller configured to control the of compute tiles. Each compute tiles includes, in part, a multitude of multiplying bit-cells (MBC) disposed along M rows and N columns, where M an N are integers greater than one. Each MBC is configured to: multiply a first bit by a second bit to generate a multiplication value; convert the multiplication value to a charge; and store the charge in a capacitor disposed in the MBC.

### RELATED APPLICATION

The present application claims benefit under 35 USC 119(e) of U.S. Patent Application No. 63/449,032, filed Feb. 28, 2023, the content of which is incorporated herein by reference in its entirety.

### TECHNICAL FIELD

The present disclosure relates to a compute fabric, and more particularly to compute fabric controlled by a machine learning/artificial intelligence system.

### BACKGROUND

A key part in artificial intelligence and machine learning is the computationally intensive task of matrix multiplication. Matrix multiplication or matrix product is a mathematical operation that produces a matrix from two matrices with entries in a field, or, more generally, in a ring or even a semi-ring. The matrix product is designed for representing the composition of linear maps that are represented by matrices. Matrix multiplication is thus a basic tool of linear algebra, and as such has numerous applications in many areas of mathematics, as well as in applied mathematics, statistics, physics, economics, and engineering. In more detail, if A is an n×m matrix and B is an m×p matrix, their matrix product AB is an n×p matrix, in which the m entries across a row of A are multiplied with the m entries down a column of B and summed to produce an entry of AB. When two linear maps are represented by matrices, then the matrix product represents the composition of the two maps.

Computing matrix products is a central operation in all computational applications of linear algebra. Its computational complexity is O(n³) (for n×n matrices) for the basic algorithm (this complexity is O(n^{2.373}) for the asymptotically fastest known algorithm). This nonlinear complexity means that matrix product is often the critical part of many algorithms. This is enforced by the fact that many operations on matrices, such as matrix inversion, determinant, solving systems of linear equations, have the same complexity. Therefore various algorithms have been devised for computing products of large matrices, taking into account the architecture of computers.

Matrix multiplication is at the heart of all machine learning algorithms and is the most computationally expensive task in these applications. Most machine learning implementations use general-purpose CPUs and perform matrix multiplications in serial fashion. The serial computations in the digital domain together with limited memory bandwidth sets a limit on maximum throughput and power efficiency of the computing system.

### SUMMARY

A compute fabric, in accordance with one embodiment of the present disclosure, includes, in part, a multitude of compute tiles disposed in a memory block; a networking circuit coupled to the compute tiles and adapted to enable communication between the compute tiles, and further to enable the compute tiles to communicate with a system external to the compute fabric; and a controller configured to control the compute tiles. Each compute tiles includes, in part, a multitude of multiplying bit-cells (MBC) disposed along M rows and N columns, where M an N are integers greater than one. Each MBC is configured to: multiply a first bit by a second bit to generate a multiplication value; convert the multiplication value to a charge; and store the charge in a capacitor disposed in the MBC.

In one embodiment, the multitude of multiplying bit-cells are configured to multiply a first binary number by a second binary number, wherein the first bit is a bit disposed in a first binary number, and the second bit is a bit disposed in the second binary number. In one embodiment, the controller is configured to control power usage associated with the multitude of multiplying bit-cells. In one embodiment, the controller is configured to control a latency associated with the multitude of multiplying bit-cells.

In one embodiment, the controller is configured to control a throughput associated with the multitude of multiplying bit-cells. In one embodiment, the controller is configured to control parallelization of the multitude of compute tiles. In one embodiment, the controller is configured to control flow of data between the multitude of compute tiles and the networking circuit. In one embodiment, each MBC includes, in part, a circuit configured to perform a multiply-and-accumulate (MAC) operation, and a static random access memory cell. In one embodiment, the first binary number is an input to the compute fabric and the second binary number is stored in the memory block.

In one embodiment, the controller is configured to control the resolution of the compute tiles by dynamically programming the number of clock cycles corresponding to which the first binary number is delivered to at least one of the compute tiles. In one embodiment, the controller is configured to control the resolution of the compute tiles by selecting the number of memory cells that are used for the MAC operation. In one embodiment, the controller is configured to control the resolution of the compute tiles by programming the number of steps performed in a binary search associated with a successive approximation register disposed in a compute tile.

In one embodiment, the compute fabric is further configured to: receive a first set of input bits associated with a first matrix; receive a second set of input bits associated with a second matrix; distribute a first subset of the first input bits to a first group of the compute tiles; distribute a second subset of the first input bits to a second group of the compute tiles; distribute a first subset of the second input bits to a third group of the compute tiles; distribute a second subset of the second input bits to a fourth group of the compute tiles; instruct the first group of the compute tiles and the third group of the compute tiles to generate a matrix multiplication of the first subset of the first input bits by the first subset of the second input bit to generate a first partial summation; instruct the second group of the compute tiles and the fourth group of the compute tiles to generate a matrix multiplication of the second subset of the first input bits by the second subset of the second input bit to generate a second partial summation; and combine the first and second partial summation to generate the result of the multiplication of the first matrix with the second matrix.

In one embodiment, the compute tiles are disposed along one or more rows. In one embodiment, the compute tiles are disposed along one or more columns. In one embodiment, the compute tiles are disposed along an array of one or more rows and one or more columns. In one embodiment, the controller is configured to control the resolution of a successive approximation register (SAR) analog-to-digital converter (ADC) disposed in a compute tile. In one embodiment, the controller is configured to vary a reference voltage used by the ADC. In one embodiment, the controller is configured to vary the number of computations performed by a compute tile.

In one embodiment, the compute fabric further includes, in part, a performance monitor. The controller is trained to vary the configuration of the compute fabric via reinforcement learning that includes, in part, setting a configuration state of the compute fabric to a first state; measuring the performance characteristic of the compute fabric by the performance monitor; receiving a reward signal in response to the measured performance characteristics and repeating the setting, the measuring and the receiving until the received reward reaches a maximum value.

In one embodiment, the performance characteristic includes one or more of power usage, throughput, latency, and resolution. In one embodiment, the configuration state of the compute fabric is defined by one or more of data path width between the compute tiles, the number of bits of input data in which the first bit is disposed, the resolution of the successive approximation register (SAR) analog-to-digital converter (ADC) associated with a compute tile, a reference voltage used by the ADC, and the number of computations performed by a compute tile.

A method of computation, in accordance with one embodiment of the present disclosure, includes, in part: forming a multitude of compute tiles in a memory block: enabling communication between the compute tiles and between the compute tiles and an external system; and controlling the compute tiles. Each compute tile includes, in part, a multitude of multiplying bit-cells (MBC) disposed along M rows and N columns, where M an N are integers greater than one. Each MBC is configured to: multiply a first bit by a second bit to generate a multiplication value; convert the multiplication value to a charge; and store the charge in a capacitor disposed in the MBC.

In one embodiment, the multiplying bit-cells are configured to multiply a first binary number by a second binary number, wherein the first bit is a bit disposed in a first binary number, and the second bit is a bit disposed in the second binary number. The method, in accordance with one embodiment, includes, in part, varying the power usage associated with the plurality of multiplying bit-cells. The method, in accordance with one embodiment, includes, in part, varying the latency associated with the multiplying bit-cells.

The method, in accordance with one embodiment, includes, in part, varying the throughput associated with the multiplying bit-cells. The method, in accordance with one embodiment, includes, in part, varying the parallelization of the compute tiles. The method, in accordance with one embodiment, includes, in part, varying the flow of data between the compute tiles.

In one embodiment, each MBC includes, in part, a circuit configured to perform a multiply-and-accumulate (MAC) operation, and a static random access memory cell. In one embodiment, the first binary number is an input to the compute fabric and the second binary number is stored in the memory block.

The method, in accordance with one embodiment, includes, in part, varying the resolution of the compute tiles by dynamically programming the number of clock cycles corresponding to which the first binary number is delivered to at least one of the compute tiles. The method, in accordance with one embodiment, includes, in part, varying the resolution of the compute tiles by selecting the number of memory cells that are used for the MAC operation. The method, in accordance with one embodiment, includes, in part, controlling the resolution of the compute tiles by programming the number of steps performed in a binary search associated with a successive approximation register disposed in a compute tile.

The method, in accordance with one embodiment, includes, in part: receiving a first set of input bits associated with a first matrix; receiving a second set of input bits associated with a second matrix; distributing a first subset of the first input bits to a first group of the compute tiles; distributing a second subset of the first input bits to a second group of the compute tiles; distributing a first subset of the second input bits to a third group of the compute tiles; distributing a second subset of the second input bits to a fourth group of the compute tiles; instructing the first group of the compute tiles and the third group of the compute tiles to generate a matrix multiplication of the first subset of the first input bits by the first subset of the second input bit to generate a first partial summation; instructing the second group of the tiles and the fourth group of the compute tiles to generate a matrix multiplication of the second subset of the first input bits by the second subset of the second input bit to generate a second partial summation; and combining the first and second partial summation to generate result of the multiplication of the first matrix with the second matrix.

In one embodiment of the method, the compute tiles are disposed along one or more rows. In one embodiment of the method, the compute tiles are disposed along one or more columns. In one embodiment of the method, the compute tiles are disposed along an array of one or more rows and one or more columns.

In one embodiment of the method, the controller is configured to control the resolution of a successive approximation register (SAR) analog-to-digital converter (ADC) disposed in a compute tile. In one embodiment, the method further includes, in part, varying a reference voltage used by the ADC. In one embodiment, the method further includes, in part, varying the number of computations performed by a compute tile.

In one embodiment, the method further includes, in part: setting a configuration state of the compute fabric to a first state; measuring a performance characteristic of the compute fabric; receiving a reward signal in response to the measured performance characteristic; and repeating the setting, the measuring and the receiving until the received reward reaches a maximum value.

In one embodiment of the method, the performance characteristics includes, in part, one or more of power usage, throughput, latency, and resolution. In one embodiment of the method, the configuration state is defined by one or more of data path width between the compute tiles, the number of bits of input data in which the first bit is disposed, the resolution of a successive approximation register (SAR) analog-to-digital converter (ADC) associated with a compute tile, a reference voltage used by the ADC, and the number of computations performed by a compute tile.

### BRIEF DESCRIPTION OF THE DRAWINGS

The following Detailed Description, Figures, and appended Claims signify the nature and advantages of the innovations, embodiments and/or examples of the claimed inventions. All of the Figures signify innovations, embodiments, and/or examples of the claimed inventions for purposes of illustration only and do not limit the scope of the claimed inventions. Such Figures are not necessarily drawn to scale, and are part of the Disclosure.

FIG. 1 is a top-level view of a multiplier, in accordance with one embodiment of the present disclosure.

FIGS. 2A-2C show an exemplary switched capacitor matrix multiplier with a successive approximation register (SAR) for use with embodiments of the present disclosure.

FIGS. 3A-3B show an exemplary 2-bit switched capacitor matrix multiplier, in accordance with one embodiments of the present disclosure.

FIG. 4A-4H show an exemplary 3-bit switched capacitor matrix multiplier, in accordance with one embodiments of the present disclosure.

FIG. 5 illustrates a method by which the worst-case error in a MAC result can be calculated for an incomplete MAC operation.

FIG. 6 is a high-level simplified schematic diagram of a multiplying bit-cell, in accordance with one embodiment of the present disclosure.

FIG. 7 shows an array of multiplying bit-cells, in accordance with one embodiment of the present disclosure.

FIG. 8 shows the connections between an array of multiplying bit-cells, in accordance with one exemplary embodiment of the present disclosure.

FIG. 9 is a simplified high-level block diagram of a hardware accelerator compute fabric, in accordance with one embodiment of the present disclosure.

FIG. 10 shows the hardware accelerator compute fabric of FIG. 9 being controlled by a machine learning agent, in accordance with another embodiment of the present disclosure.

FIG. 11 shows a configurable compute fabric, in accordance with one embodiment of the present disclosure.

FIG. 12 is an example of the source and destination addresses in the instruction cache of the compute fabric of FIG. 11 that instructs the controller of the compute fabric how to configure the data paths of the compute fabric, in accordance with one embodiment of the present disclosure.

FIG. 13 shows the controller and a number of other blocks of the compute fabric of FIG. 11 during a training phase, in accordance with one embodiment of the present disclosure.

### DETAILED DESCRIPTION

One aspect of the present disclosure relates to a general-purpose low power switched capacitor Vector-Matrix Multiplier (VMM). A significant power efficiency is achieved by performing multiply-and-accumulate in analog domain and storing weight values locally so that power hungry data communication between memory and computational unit is eliminated. The vector-matrix multiplier computes N inner products of n-dimensional inputs with m-dimensional weights in parallel as shown in equation (1) below:

$${Y}_{1 \times N}^{( n )} = {X}_{1 \times N}^{( n )} \cdot {W}_{N \times N}^{( m )} \qquad ( 1 )$$

Inner product multiplication described by Equation (1), can be expanded in a bit-wise fashion as follows:

$$y = {\sum }_{k = 0}^{m - 1} ( {\sum }_{j = 0}^{n - 1} ( {\sum }_{i = 0}^{N - 1} {x}_{i}^{j} \cdot {w}_{i}^{k} ) \cdot {2}^{j} ) \cdot {2}^{k} \qquad ( 2 )$$

where N is the number of inputs and weights, n is the number of bits in the inputs, m is the number of bits in the weights, xᵢ^{j} is the j-th bit of the i-th input and wᵢ^{k} is k-th bit of the i-th weight.

Generally, N, n and m set an upper limit on k (output resolution) in Equation (1):

$$k \leq n + m + {log}_{2} ( N ) \qquad ( 3 )$$

For n-bit inputs and m-bit weights there will be n·m cycles required to compute the result, where “.” represents the multiplication operation. However, if k is set to anything lower than its upper limit, not all cycles will be necessary. For example, for a 256-input inner product multiplier with 8-bit inputs, weights and outputs and a Successive Approximation Register (SAR), described further below, with 8-bit resolution, there will be only 49 (as opposed to 64) cycles required to guarantee that the approximated multiply-and-accumulate (MAC) result is within one Least Significant Bit (LSB) from its true value in the worst case where all inputs and weight are 255 (for random inputs and weights this further reduces to only 36 cycles).

Output resolutions higher than SAR's resolution can be achieved by running the SAR quantization on partial MAC results one or more times throughout MAC operation. For example, a 16-bit output can be achieved by running SAR quantization once for every 8 MAC cycles and then scaling and summing the results in the digital domain. This way, any output resolution from 1 to n+m+log₂(N) can be achieved with this architecture.

An analog implementation provides a natural medium to implement fully parallel computational arrays with high integration density and energy efficiency. By summing charges on each capacitor in a large capacitor bank, a switched capacitor vector-matrix multiplier can accomplish a massively parallel multiply-and-accumulate with low latency.

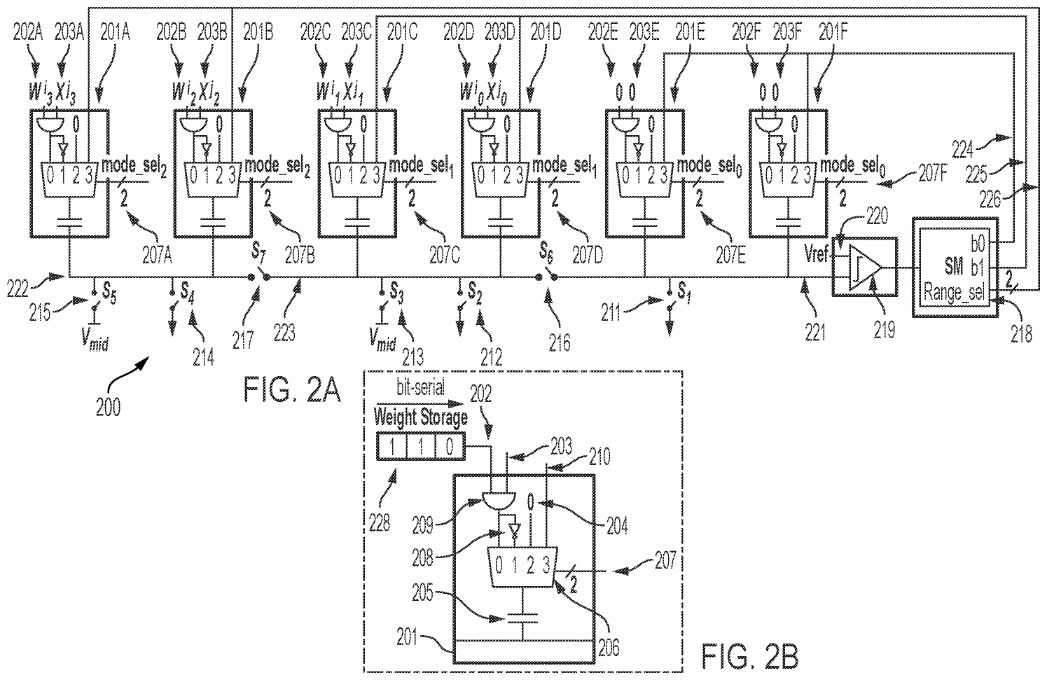

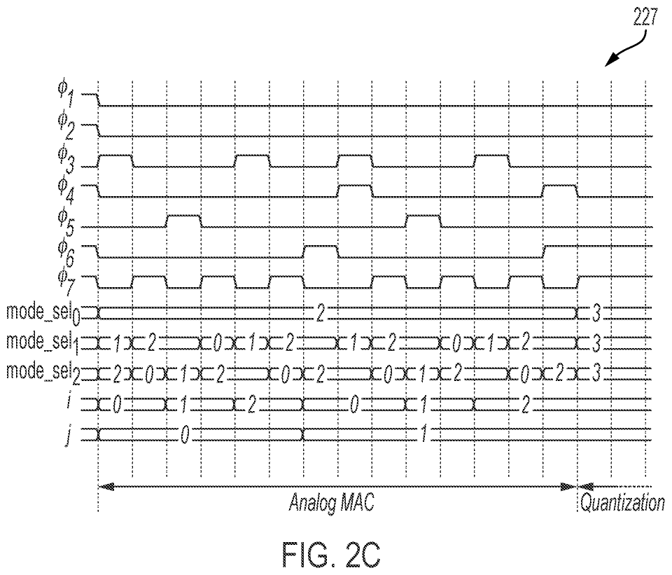

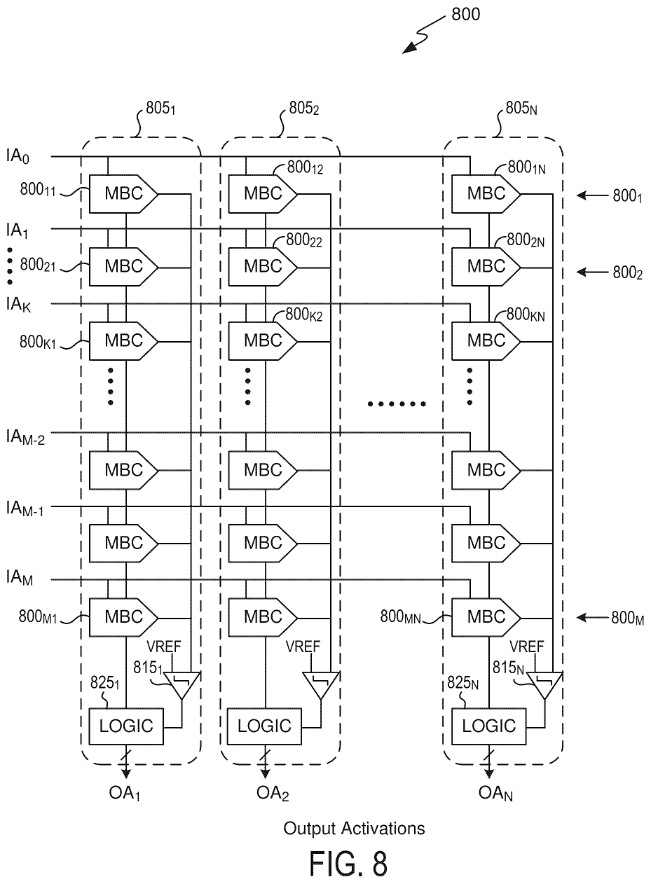

The switched capacitor vector-matrix multiplier comprises a Successive Approximation Register (SAR) Analog to Digital Converter (ADC) (disposed in FIG. 2A described below) per MAC, or per neuron described further below with reference to FIG. 8. The capacitor bank of each SAR is not binary weighted and is expanded to provide one connection per multiplying bit cells, described further below. Inputs and weights are implemented digitally in bit-serial fashion. SAR architecture according to certain embodiments provides a low power solution that inherently contains both a DAC and an ADC. The ADC quantizes the result of each MAC operation which can be used as an input to the next stage while DAC converts the digital codes back into analog charges which are accumulated in MAC operation. This process makes this architecture highly scalable and can be cascaded many times to implement a very large neural network. Carrying out quantization by a SAR ADC has an added advantage of dynamically lowering the resolution of the results for applications that require faster and more power efficient but less precise computations. An N×N matrix multiplier can be constructed by an array of N switched capacitor vector-vector inner multiplier each with N inputs and a log 2(N) bit resolution SAR. The distributed nature of local storage of the results absolves the need for high bandwidth memory and significantly increases the power efficiency of the system. Moreover, storing the results digitally allows for reconfigurable digital post-processing and can be used to apply non-linearity.

Multiplication of matrices larger than the physical structure of a switched capacitor matrix multiplier can be accomplished by performing partial matrix multiplication of the size of the available switched capacitor matrix multiplier and then storing and recombining the partial results locally.

The digital interface of SAR's capacitive DAC inputs and the state machine outputs can be modified to incorporate inner product computation into SAR. By multiplexing the SAR's state machine's digital outputs with bit-wise product of inputs and weights, SAR can operate in two separate phases: Accumulation phase in which inputs and weights are bit-wise multiplied using simple AND gates and results accumulated on the shared node of the capacitive DAC, and Conversion phase in which normal SAR operation results in digital quantization of the accumulated result. By scaling down the previous MAC result by a factor of two and adding it to the MAC result of next consecutive bit of inputs or weights before SAR quantization starts, more resolution can be incorporated into the final MAC output. This way, resolution of inputs and weights can be set arbitrarily high and, on the fly, though at the expense of energy and speed.

The interface between SAR's DAC inputs and the state machine outputs may be embedded in a memory. By storing weights locally using cross-coupled inverters, memory access and computations can be carried out locally and at the same time obviating the need for energy-expensive data movements to and from memory. Such distributed memory system can be thought of as a Static Random Access Memory (SRAM) with embedded bit-wise multipliers (AND gates) whose memory cells are capacitively coupled to the bit-lines (the shared node of the capacitive DAC) through unit capacitors of the SAR. This way, all bits stored in the SRAM can be read simultaneously as long as SAR has enough precision to resolve the amount of charge injected by a single memory cell. Because of this In-Memory-Computation, a significant area and power saving can be achieved.

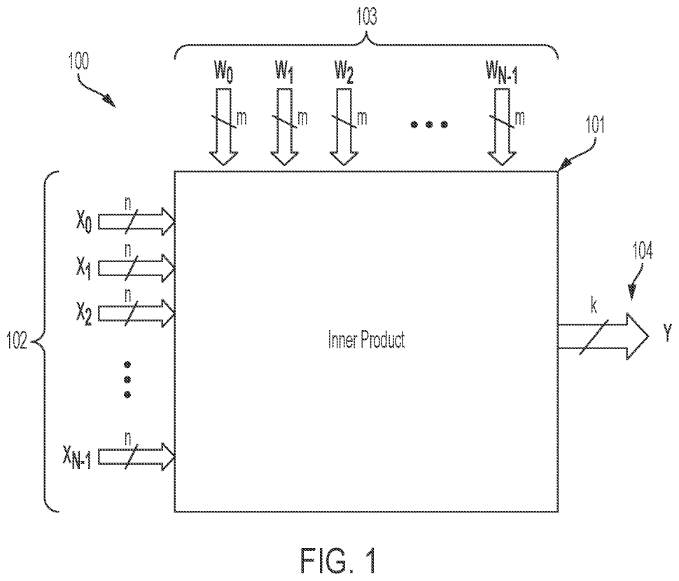

FIG. 1 illustrates a top-level diagram of an exemplary switched capacitor vector-vector inner multiplier 100. In FIG. 1, multiplier 100 computes N inner products 101 of n-bit inputs (X₀ . . . X_{N-1}) 102 with m-bit weights (W₀ . . . W_{N-1}) 103 in parallel. Multiplier 100 produces one k-bit output (Y) 104.

FIG. 2A illustrates an implementation of an exemplary successive approximation register (SAR) 200 ADC for use with some embodiments of the present disclosure. SAR 200 is shown as comprising a plurality of (e.g., six (6) in FIG. 2A) MAC circuits 201A-201F that are connected. Each of MAC circuits 201A-201F (shown in expanded view of 201 in FIG. 2B) comprises a multiplexer 206, a capacitor 205, successive approximation register (SAR) local memory 228 for storing weight values, an AND gate 209, and an inverter 208 where the AND gate and the inverter are connected in series. A 2-bit input 207 to the multiplexer 206 selects between the output of the AND gate 209 for value ‘0’, output of the inverter 208 for value ‘1’, ground 204 for value ‘2’, or an input 210 from SAR state machine 218 for value ‘3’ and drives the SAR capacitor 205.

In some embodiments, SAR 200 further comprises reset switches S₁-S₇ 211-217. Switches S₄ 214 and S₅ 215 connect the shared output of MAC circuits 201A and 201B 222 to ground and V_{mid} respectively. V_{mid} is set to half of SAR supply voltage. Switches S₂ 212 and S₃ 213 connect the shared output of MAC circuits 201C and 201D 223 to ground and V_{mid} respectively. A switch S₁ 211 connects the shared output of MAC circuits 201E and 201F 221 to ground. A switch S₆ 216 connects the shared output of MAC circuits 201E and 201F 221 to the shared output of MAC circuits 201C and 201D 223. A switch S₇ 217 connects the shared output of MAC circuits 201A and 201B 222 to the shared output of MAC circuits 201C and 201D 223. The timing diagram 227 illustrates the orientation of the switches S₁-S₇ in Analog MAC operation and Quantization stages of the matrix multiplier. Signals φ₁-φ₇ drive switches S₁-S₇ respectively such that when signals φ₁-φ₇ are high S₁-S₇ are closed and when signals φ₁-φ₇ are low S₁-S₇ are open.

In embodiments, SAR 200 further comprises a comparator 219 and a state machine 218. Comparator 219 compares a reference voltage V_{ref} 220 to an output voltage 221 of the MAC circuits 201E-201F to provide an input for the state machine SM 218. State machine SM 218 provides an output b0 224 that is fed back to a MAC circuit 201E, an output b1 225 that is fed back to MAC circuits 201C and 201D, and a 2-bit output Range_sel where one bit is fed back to MAC circuit 201A and the other bit is fed back to MAC circuit 201B.

In some embodiments, SAR 200 further comprises 2-bit signals modeₛₑₗ_{₀}, modeₛₑₗ_{₁}, modeₛₑₗ_{₂}, modeₛₑₗ_{₀} is connected to multiplexer select signal 207E and 207F of MAC circuits 201E and 201F, modeₛₑₗ_{₁} is connected to multiplexer select signal 207C and 207D of MAC circuits 201C and 201D, modeₛₑₗ_{₂} is connected to multiplexer select signal 207A and 207B of MAC circuits 201A and 201B. The timing diagram 227 in FIG. 2C illustrates the value of modeₛₑₗ_{₀}, modeₛₑₗ_{₁}, modeₛₑₗ_{₂} in MAC and quantization stages of switched capacitor matrix multiplier.

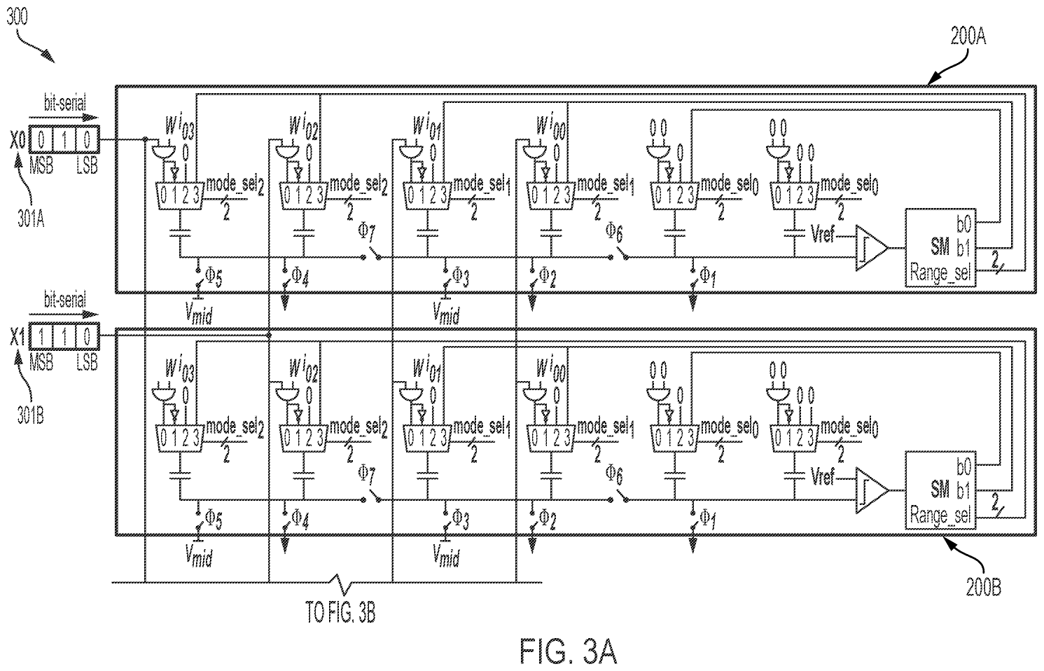

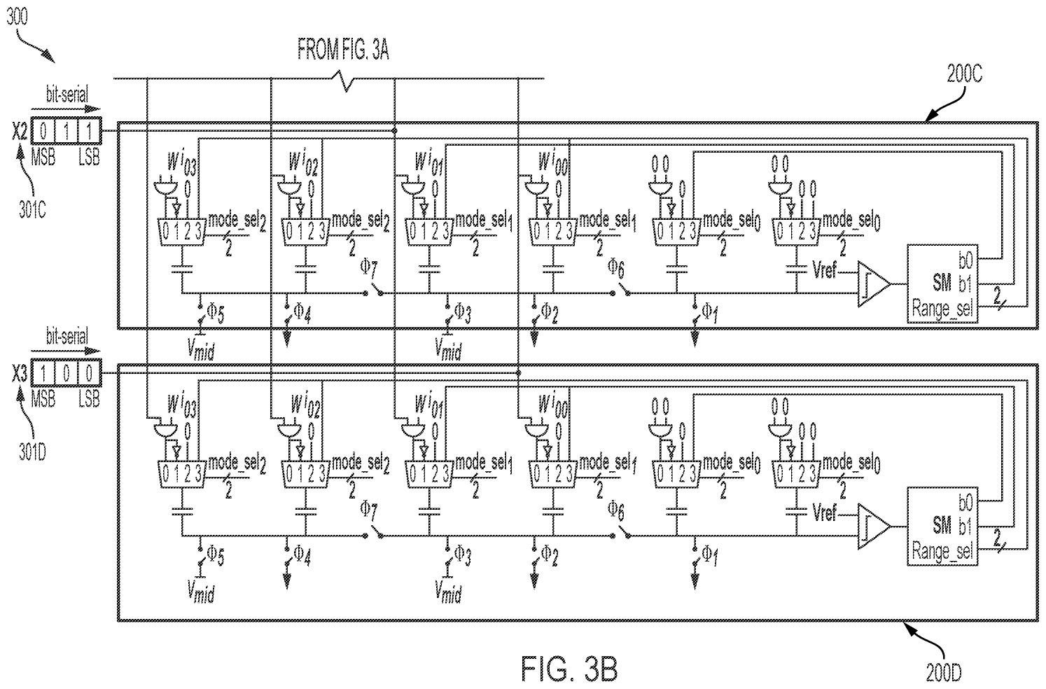

FIGS. 3A and 3B illustrates 2-bit implementation of an exemplary switched capacitor matrix multiplier 300 in accordance with one embodiment of the present disclosure. In some embodiments, switched capacitor matrix multiplier 300 comprises a plurality of SARs 200A-200D (e.g., four (4) in FIGS. 3A and 3B), each having a configuration as described with respect to and depicted in FIG. 2A. In some embodiments, switched capacitor matrix multiplier 300 further comprises a plurality of (e.g., four (4) in FIGS. 3A and 3B) local memory 301A-301D for storing input values.

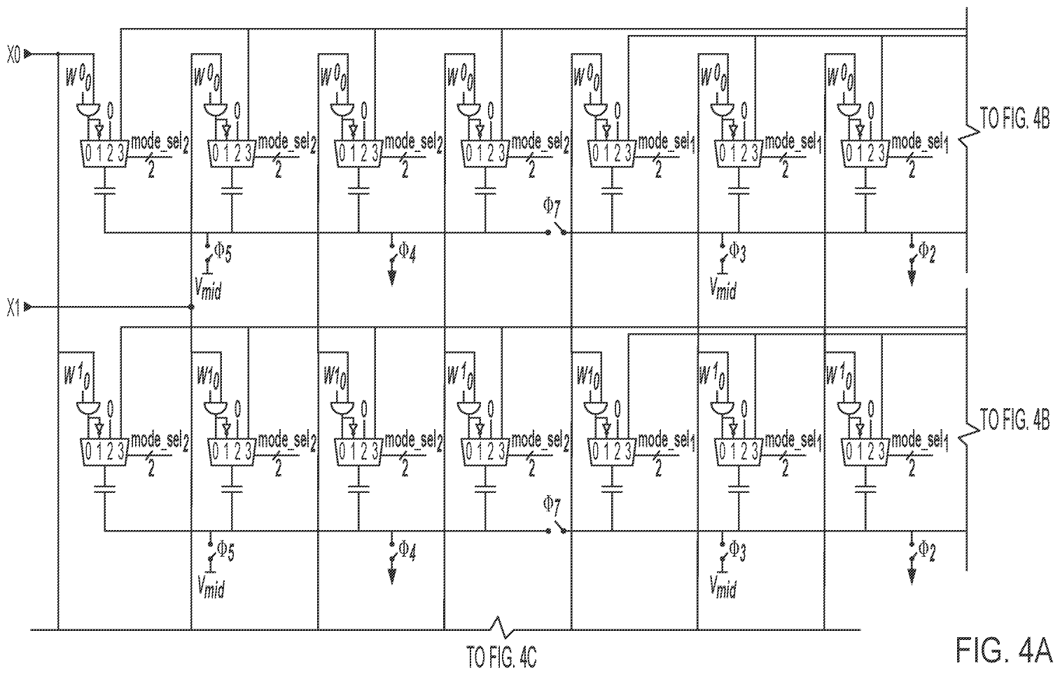

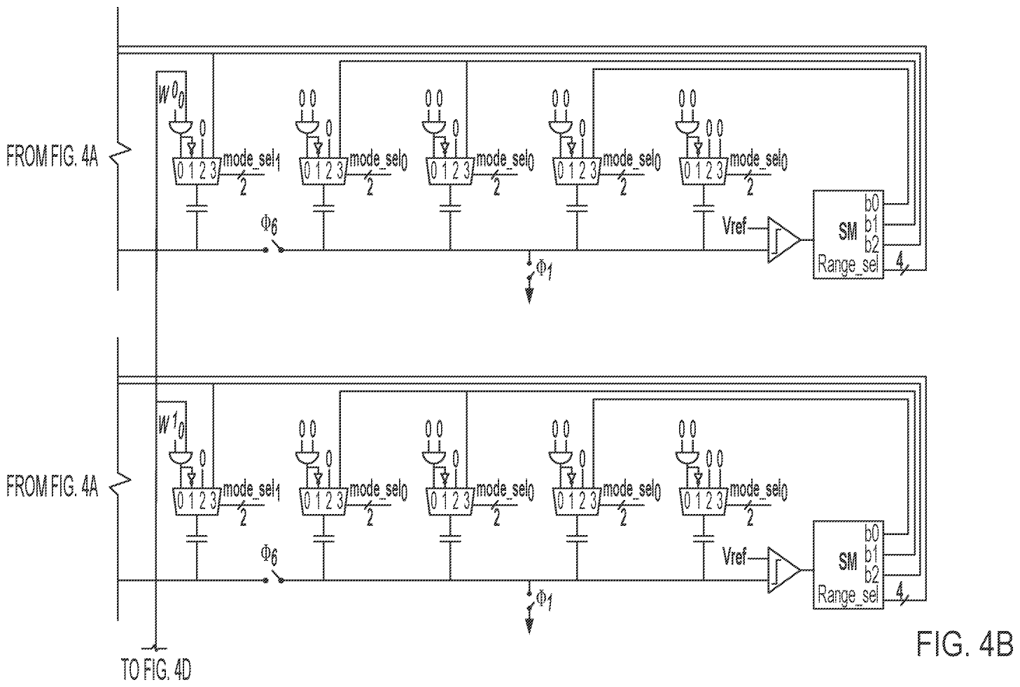

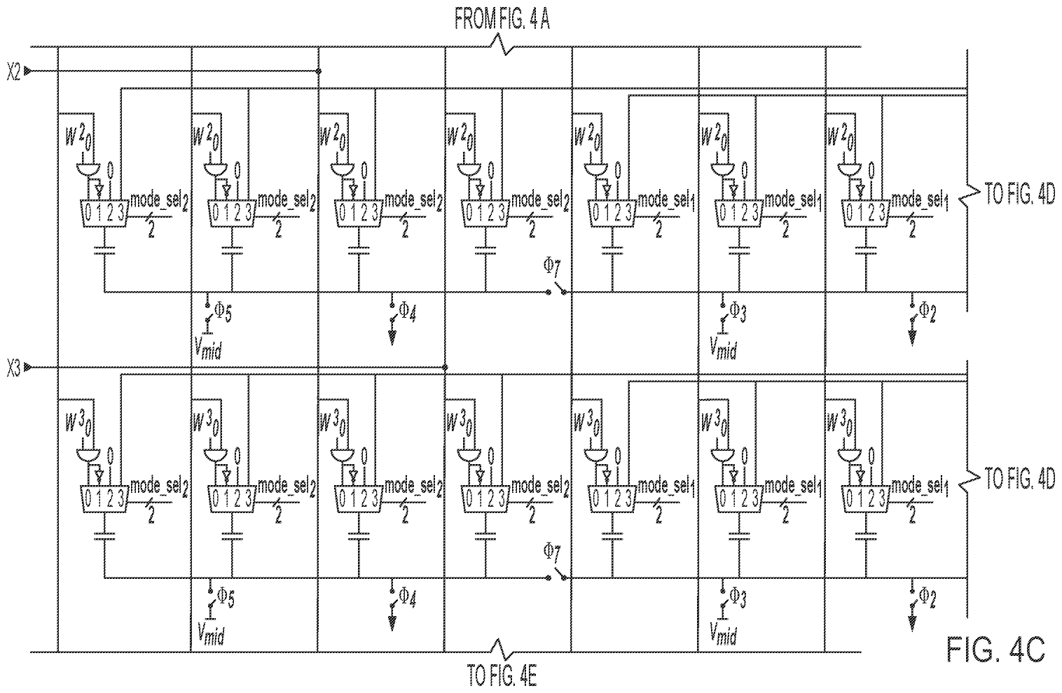

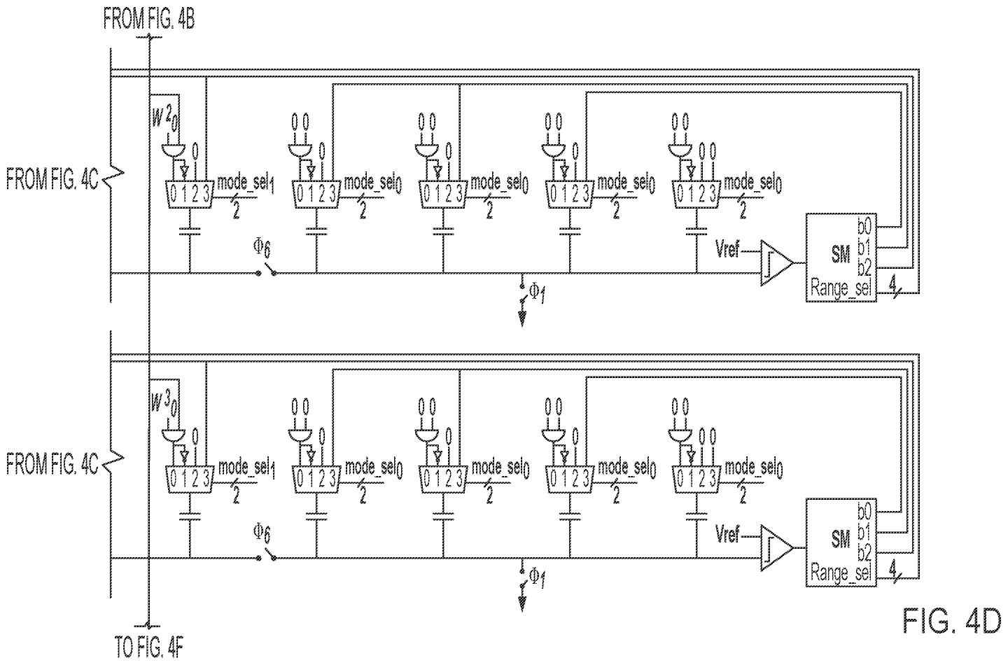

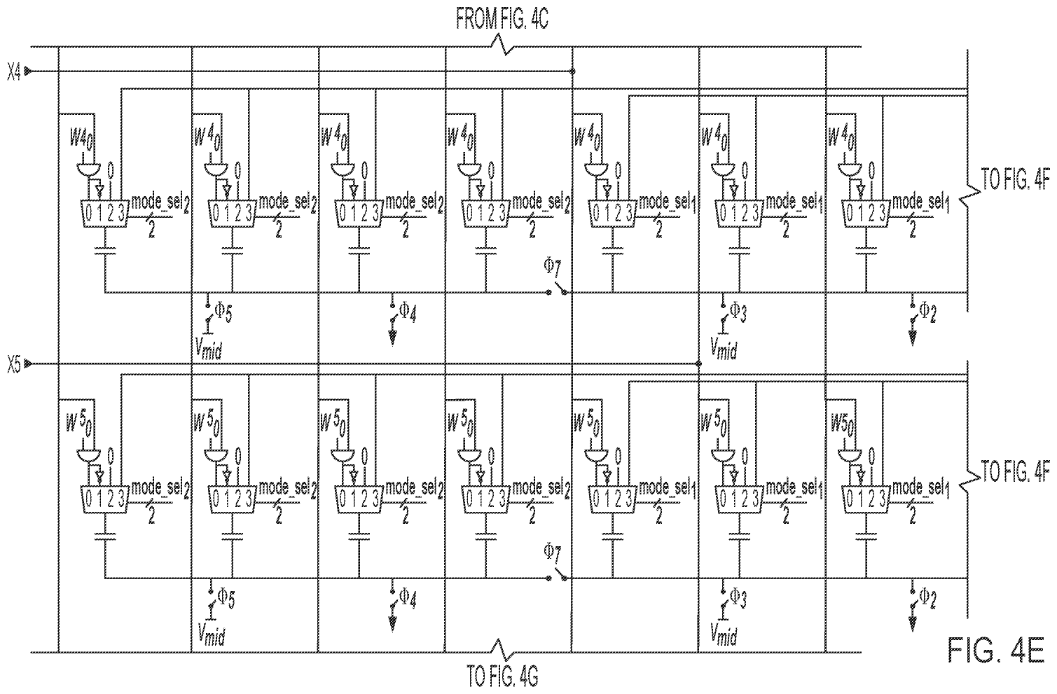

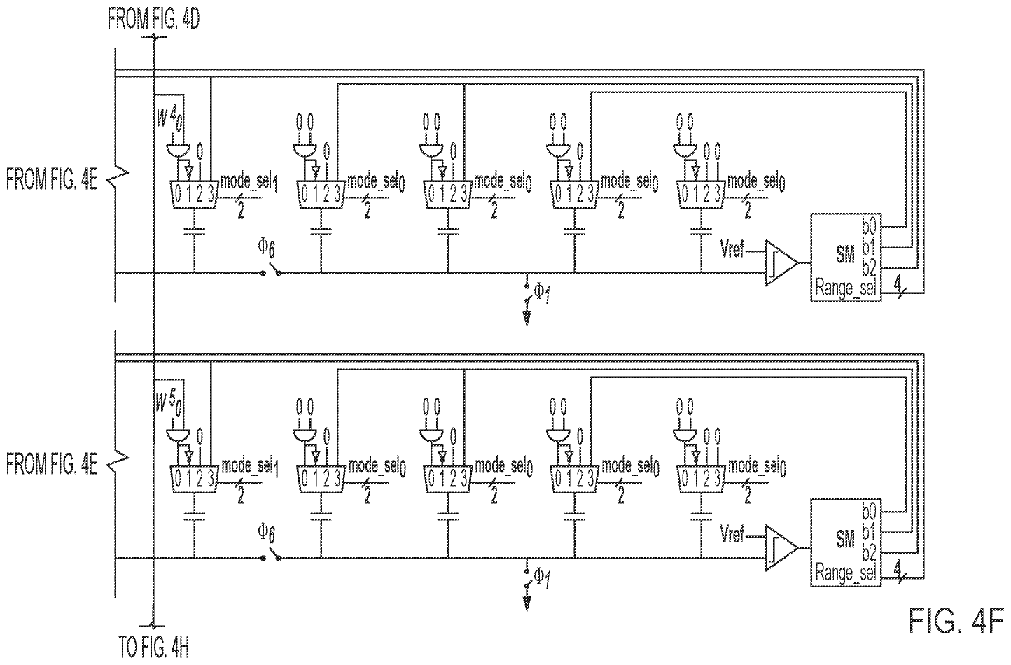

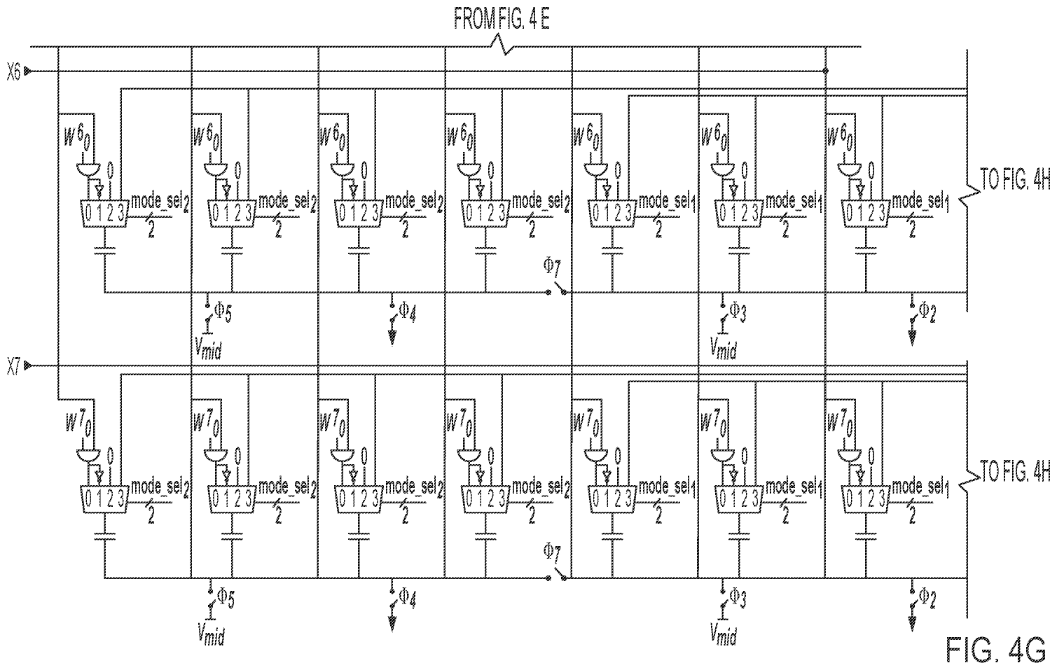

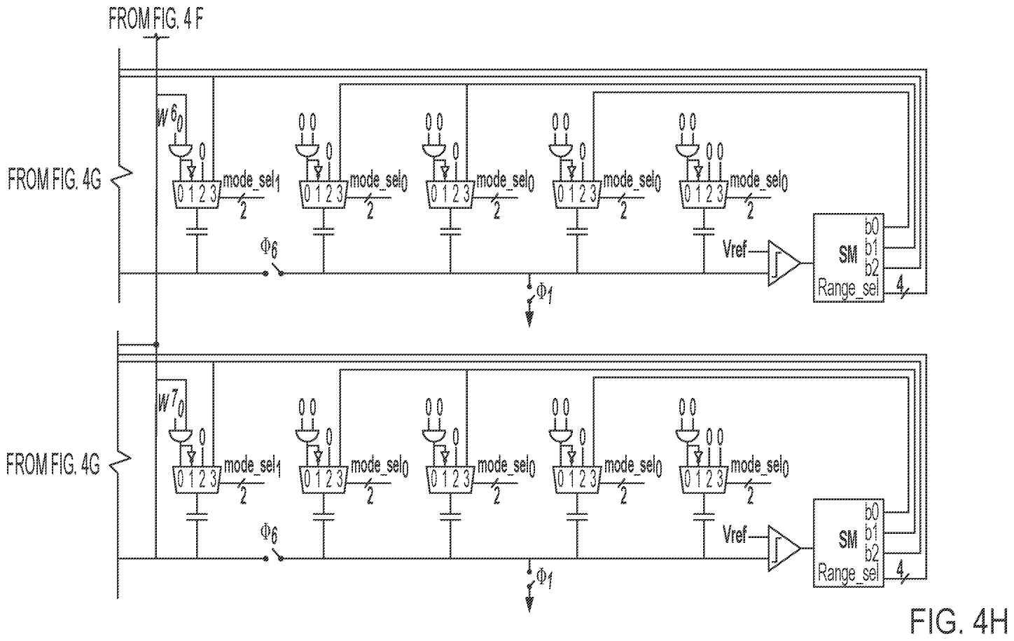

FIGS. 4A, 4B, 4C, 4D, 4E, 4F, 4G and 4H illustrate a 3-bit implementation of an exemplary switched capacitor matrix multiplier 400 according to one embodiments of the present disclosure. As shown, switched capacitor matrix multiplier 400 comprises a plurality of SARs (e.g., eight (8) as shown), each having a configuration similar to that discussed above in reference to FIGS. 2A and 2B. However, as shown in FIGS. 4A, 4B, 4C, 4D, 4E, 4F, 4G and 4H, each SAR may comprise twelve (12) MAC circuits each having a functionality similar to that discussed above. Such a configuration provides a matrix multiplier having a different resolution and number of inputs to that shown in FIGS. 2A and 2B. Specifically, the configuration of FIG. 4A-4H provides a 3-bit matrix multiplier configured for utilizing 8 inputs. It is understood that the 2-bit matrix multiplier configuration of FIGS. 2A and 2B and the 3-bit matrix multiplier of FIGS. 4A-4H are merely examples of various matrix multiplier configurations that may embody various embodiments.

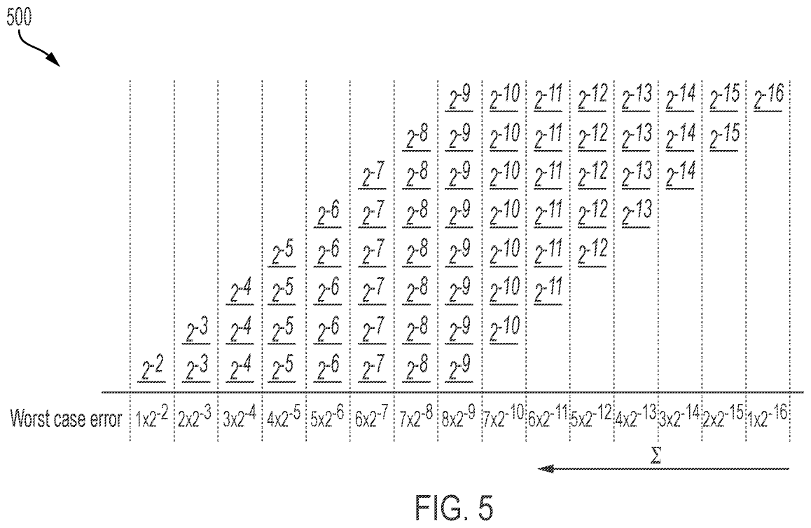

FIG. 5 illustrates a method by which the worst-case error in a MAC result can be calculated. By summing the numbers in the diagram starting from upper right corner and moving down and to the left one can calculate the worst case error. Accordingly, the worst-case error after 49 cycles will be:

$$\frac{5 \times {2}^{- 12} + 4 \times {2}^{- 13} + 3 \times {2}^{- 14} + 2 \times {2}^{- 15} + 1 \times {2}^{- 16}}{{2}^{- 8}} \approx 0.5 LSB \qquad ( 4 )$$

It is understood that “weight” and “bit-wise” weight are used herein interchangeably.

### Exemplary Multiply-and-Accumulate (MAC) and Quantization Operation

MAC stage or operation of the exemplary switched capacitor vector matrix multiplier starts by multiplying the Least Significant Bit (LSB) of inputs and weights (k=j=0) and shorting the shared node of MAC circuits 201C and 201D (e.g., 223 in FIG. 2A) to V_{mid} through S₃ (e.g., 213 in FIG. 2A) while shorting the top plates of the SAR capacitors (e.g., 205 in FIG. 2B) in MAC circuits 201C and 201D to the output of inverter (e.g., 208 in FIG. 2B) by setting modeₛₑₗ_{₁} to ‘1’. The shared nodes of MAC circuits 201A and 201B (e.g., 222 in FIG. 2A) and MAC circuits 201E and 201F (e.g., 221 in FIG. 2A) are shorted to ground via switches S₄ (e.g., 214 in FIG. 2A) and S₁ (e.g., 211 in FIG. 2A) respectively and modeₛₑₗ_{₀} and modeₛₑₗ_{₂} are set to ‘2’. Switches S₆ (e.g., 216 in FIG. 2A) and S₇ (e.g., 217 in FIG. 2A) are open.

The switch S₇ then closes shorting nodes 222 and 223 in FIG. 2A and top plates of SAR capacitors in MAC circuits 201C and 201D are shorted to ground by setting modeₛₑₗ_{₁} to ‘2’. The top plates of SAR capacitors in MAC circuits 201A and 201B are shorted to the output of AND gate (e.g., 209 in FIG. 2B) by setting modeₛₑₗ_{₁} to ‘0’. S₇ then opens and bit index of inputs is incremented by one (e.g., 203 in FIG. 2B). The bottom plates of capacitors in MAC circuits 201A and 201B are shorted to V_{mid} through S₅ (e.g., 215 in FIG. 2A) and top plates to the output of inverter (e.g., 208 in FIG. 2B) by setting modeₛₑₗ_{₁} to ‘1’ while the SAR capacitors in MAC circuits 201C and 201D are holding the result of the previous MAC operation.

When S₇ closes again and modeₛₑₗ_{₁} and modeₛₑₗ_{₂} are set to ‘0’ and ‘2’ respectively, new charge is added to the SAR capacitors of the MAC circuits 201A-D and the previously stored charge on the SAR capacitors of MAC circuits 201C and 201D is now shared between SAR capacitors of MAC circuits 201A-D. Therefore, the previous MAC result is halved and accumulated with the new MAC result. This pattern repeats scaling the previous result by a factor of two and accumulating it with the new MAC result every time S₇ closes then incrementing bit index of inputs until all bits in the input are multiplied by the LSB of the weights. Then S₇ opens and S₆ closes dividing the accumulated result by two and storing it on SAR capacitors of the MAC circuits 201E and 201F. This pattern repeats incrementing bit index of weights by one every time until all bits of weights are multiplied by all bits of inputs. Timing diagram 227 in FIG. 2C illustrates the MAC operations where n=3 and m=2 in Equation (1).

In a quantization stage/operation/process of the exemplary switched capacitor vector matrix multiplier, modeₛₑₗ_{₀}, modeₛₑₗ_{₁} and modeₛₑₗ_{₂} are set to ‘3’ and switches S₁-S₅ are open and switches S₆ and S₇ are closed. Normal SAR operation results in quantization of final MAC result. Range_sel can be used to set the overflow or underflow of the MAC result dynamically or to incorporate a threshold in matrix multiplication.

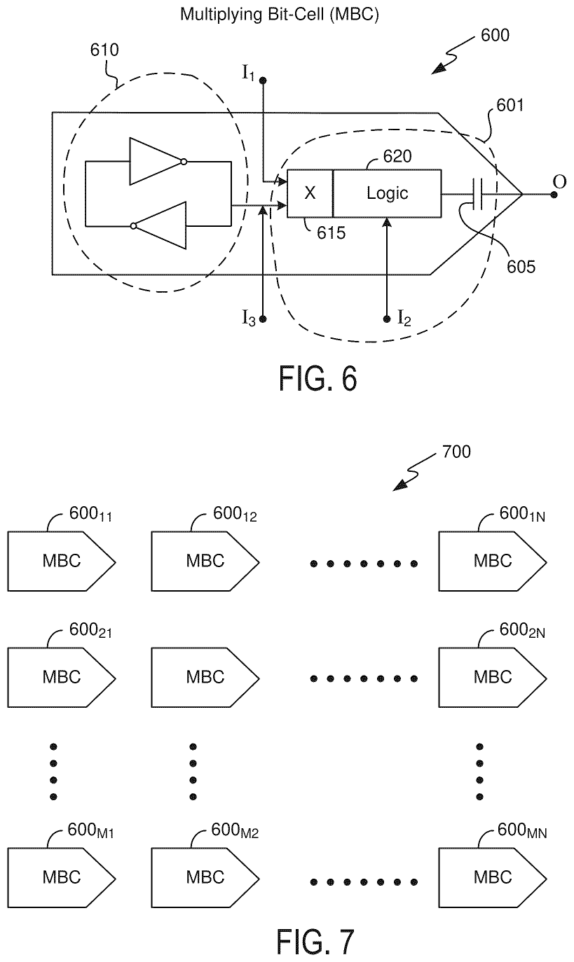

As described above, in accordance with some embodiments of the present disclosure, matrix multiplication is performed entirely in memory, such as a static random-access memory (SRAM). FIG. 6 is a high-level simplified schematic diagram of a Multiplying Bit-Cell (MBC) 600, in accordance with one embodiment of the present disclosure. MBC 600 is shown as including, in part, an SRAM cell 610 configured to store the weights, and a MAC unit 601 described in detail above, see, for example, MAC circuits (units) 201A-201F described in reference to FIGS. 2A and 2B. MBC 600 is shown as receiving, in part, input signals I₁, I₃ and generating output signal Vout representative of the product of signals I₁ and I₃. Signal I₁ represents the input signal applied to MBC 600 and signal I₃ represents the weight by which signal I₁ is multiplied. The weight represented by signal I₃ may be stored in the SRAM cell 610. The integration of the MBC does not affect the operation of the SRAM cell that is storing the weights. MBC 600 may be activated or deactivated for multiplication by logic input signal I₂. The SRAM cell remains operational for read/write access as a memory cell independent of the logic state of signal I₂. As a result, MBC 600 has a dual function, operating both as a standard memory element, as depicted by the back-to-back inverters synonymous with SRAM, which is accessible to the higher-level system, as described further below, and as a multiplying bit-cell.

FIG. 7 shows an M×N array 700 of MBCs, in accordance with one embodiment of the present disclosure. For example, row 1 is shown as including MBCs 600₁₁, 600₁₂ and 600_{1N}; and row M is shown as including MBCs 600_{M1}, 600_{M2} and 600_{MN}. Each MBC 600ᵢⱼ, where i and j refer respectively to row and column number in which a cell is disposed, corresponds to MBC 600 shown in FIG. 6. In accordance with one embodiment, array 700 of MBCs is disposed in an SRAM in its entirety.

FIG. 8 shows the connections between an exemplary M×N array 800 of MBCs, in accordance with one exemplary embodiment of the present disclosure, where M represent the number of rows of array 800, and N represents the number of columns of array 800. Each column of array 800 is referred to herein as a neuron. For example, column 1 of array 800 that includes MBC cells 800₁₁, 800₂₁ . . . 800_{M1} is shown as being associated with neuron 805₁. Similarly, for example, column N of array 800 that includes MBC cells 800_{1N}, 800_{2N} . . . 800_{MN} is shown as being associated with neuron 805_{N}. Array 800 thus includes N neurons.

Array 800 is disposed in a memory block (e.g., block of SRAM) configured to perform matrix multiplication. In one embodiment, the matrix multiplication may be performed in analog domain, as described above, using digital-to-analog (DAC) converters, multiply-and-accumulate (MAC) circuitry, and analog-to-digital (ADC) converters. It is understood that in one embodiment, the DAC, MAC and ADC operations, may be performed entirely within a memory block, e.g. an SRAM block, in which array 800 is disposed. Such a memory block, shown as array 800, is alternatively referred to herein as Compute-and-Quantize-In-Memory (CQIM) block and is alternatively referred to herein as CQIM array. In one embodiment, the matrix multiplication may be performed in a digital domain using digital multiplication circuits.

As described above, each column of CQIM array 800 forms a neuron adapted to multiply one or more inputs by one or more weights and accumulate the results also referred to herein as a vector-dot product. For example, CQIM array 800, shown as including M×N array of MBC cells 800ᵢⱼ (each of which corresponds to MBC 600 shown in FIG. 6) where i is a row index ranging from 1 to M and j is a column index ranging from 1 to N, may be configured to perform a vector-dot product of input activation signals IA₁ and IA₂ applied to MBC cells 800₁₁, 800₁₂, 800₂₁ and 800₂₂, disposed in rows 800₁ and 800₂. Assuming the weights stored in MBC cells 800₁₁, 800₁₂, 800₂₁ and 800₂₂ are respectively denoted as W₁₁, W₁₂, W₂₁ and W22₂₂ the vector-dot product may be represented as shown below:

$$[ \begin{matrix}I A 1 \\ I A 2\end{matrix} ] * [ \begin{matrix}W 11 & W 12 \\ W 21 & W 22\end{matrix} ] = [ \begin{matrix}I A 1 * W 11 + I A 1 * W 12 \\ I A 2 * W 21 + I A 2 * W 22\end{matrix} ]$$

In one embodiment, each MBC forms a CQIM tile configured to carry out matrix multiplication. In another embodiment, two or more MBCs form a CQIM tile. Such two or more MBCs may be disposed in the same row, or in the same column, or in different rows and columns. For example, in one embodiment, MBCs such as MBCs 800₁₁, 800₁₂ may be configured to form a CQIM tile. In another embodiment, MBCs such as MBCs 800₁₁, 800₂₁ may be configured to form a tile. In another embodiment, MBCs disposed in different rows and columns, such as 800₁₁, 800₁₂, 800₂₁ and 800₂₂ may be configured to form a tile. In some embodiment, the MBCs forming a tile may not be adjacent MBCs. For example, in some embodiments MBCs 800₁₁ and 800_{MN} may be configured to form a tile.

Each row of the array is shown as receiving an input activation (IA) signal. For example, IA₁ is shown as being applied to MBCs 800₁₁, 800₁₂ and 800_{1N}; IA_{M} is shown as being applied to MBCs 800_{M1}, 800_{M2} and 800_{MN}, and IAₖ is applied to MBCs 600ₖ₁, 600ₖ₂ and 600_{KN}, where k is a row index ranging from 1 to M in this example. Each input activation signal corresponds to a different signal I₁ shown in FIG. 6.

The IAᵢ signal, which has a value represented by one or more bits, received by each MBC is multiplied by the weights stored, for example, in that MBC, as described in detail above. The results of the each such multiplication is thereafter converted to a charge by the capacitor disposed in that MBC, such as capacitor 605 shown in FIG. 6. For example, IA₁ is multiplied by the weight stored in MBC 800₁₁, the result of which is converted to a charge and supplied to MBC 800₂₁. IA₂ is multiplied by the weight stored in MBC 800₂₁, the result of which is converted to a charge and added to the charge received by MBC 800₁₁. Such charges are then accumulated sequentially within each neuron to generate the MAC result for that neuron.

Referring to FIG. 6, logic block 620 disposed in MBC cell 600, in part in response to signal I₂, sends the multiplication result, after the result is converted to a charge, to the capacitor 625 for storage. In one embodiment, the logic block may be configured to provide signals that control the sequential and parallel operation of an MBC cell, 600.

Each neuron 805ⱼ is shown as including a logic block 825; and a comparator 815j receiving a reference voltage VREF. As described in detail above with reference to FIGS. 2A-2C, 3A-3B, and 4A-4H, comparator 815j is part of the integrated SAR performing the binary search. Logic block 825j furthers drive the signal applied to, for example, MAC circuit 201A shown in FIG. 2A. The application of voltages, derived from the same VREF that the comparator is comparing against, enables the binary search algorithm to iterate until the desired number of SAR output bits are achieved. MAC results are subsequently converted, processed by the SAR operation described above, on a column basis show in array 800 above, and quantized.

In accordance with some embodiments of the present disclosure, a user is enabled to program (i.e., configure) the resolution of computation for all data types independently, including data type of IAs, weights, and output activation (OA) signals OA₁, OA₂ . . . . OA_{N} supplied respectively by neurons 805₁, 805₂ . . . 805_{N}. Since the IAⱼ values, where j is a row index ranging from 1 to M in the example shown in FIG. 8, represented by digital bits and applied serially, see for example FIG. 2, the user may set the resolution of the IAⱼ value bits dynamically by programming the number of clock cycles required for the IAⱼ bits to be delivered serially to their associated CQIM tile. The number of clock cycles determines how many of the IAⱼ value bits are processed by the CQIM tile. When the number of clock cycles desired have been processed by the circuits, as shown in FIGS. 2A-2C, 3A-3B, and 4A-4H, 6, and 8, logic block 601 of the MBC block, as shown in FIG. 6, is instructed to begin the SAR operation and complete the quantization. The resolution of the weight parameters may be set by selecting the number of memory bit cells that are used for the MAC operation. As the MBC of 600 (see FIG. 6) n cells, as shown in FIGS. 2A-2C, 3A-3B, and 4A-4H, the resolution of the weight value can be set by using a only subset of the blocks 201A-201F shown in FIG. 2A. The resolution of OA bits may be set by programming the number of steps in the SAR binary search as described in previous paragraph. For instance, if the number of SAR conversion steps is set to 4, the SAR result would be a 4-bit digital output.

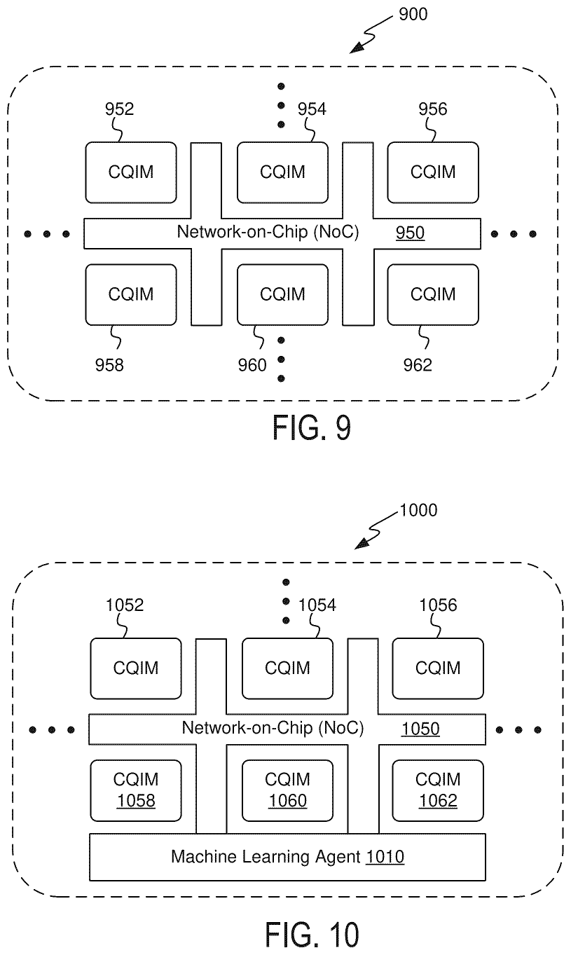

FIG. 9 is a simplified high-level block diagram of a hardware accelerator compute fabric (HACF) 900, in accordance with one embodiment of the present disclosure. HACF 900 is formed using a multitude of CQIM tiles that communicate with one another and with external devices via a network-on-chip (NoC) 950 in order to perform computations. Only six CQIM tiles 952, 954, 956, 958, 960 and 962 are shown in FIG. 9. It is understood, however, that HACF 900 may have more or fewer than 6 CQIM tiles. In one embodiment, a CQIM tile may implement one or more layers of a neural network system. Although not shown, NoC 950 is configured to route outputs of one layer of a neural network system to the inputs of a subsequent layer of the neural network system. Higher dimension matrix sizes can be distributed along multiple CQIM tiles where partial sums generated by each tile is summed together to generate the result of the matrix multiplication.

FIG. 10 is a block diagram of a HACF 1000 controlled by a machine learning agent 1010, in accordance with another embodiment of the present disclosure. HACF 1000 is shown as including, in part, a multitude of CQIM tiles 1052, 1054, 1056, 1058, 1060 and 1062, a NoC 1050, and a machine learning agent 1010. HACF 1000 may be configured and controlled by machine learning agent 1010 to, among other benefits, increase energy efficiency, reduce latency, increase throughput, enable parallelization of the CQIM tiles (i.,e., the number of CQIM tiles that may be connected in parallel by, for example, machine learning agent 1010 of FIG. 10, to enable parallelization of the operation within the compute fabric), optimize data flow on the NoC, and optimally map the computations onto the compute fabric.

A configurable matrix multiplier based on switched capacitor, SAR integrated, CQIM tiles, and associated arrays, as described above, may be optimized to achieve desired performance metrics, different modes of operation, such as power consumption, latency, through-put, and the like. Performance metrics may be measured using many different techniques. On-chip counters can count system or reference clock cycles to measure latency and through-put which can be timed to the execution of the program, program counters, or other timing and system management signals within the architecture. To measure power, for example, sense resistors may be disposed around the chip to measure the current consumed by the design. Voltage can be measured near the point of load using sense amplifiers, current references, and ADCs. Using each of such measurements alone, or in combination, will provide a measurement of the power and energy by a section of the chip, or multiple sections of the chip, allowing for optimization of the power and energy consumed. In one embodiment, described above with reference, for example, to array 800 shown in FIG. 8, a multitude of the CQIM tiles may be integrated together on the same die, across multiple dies, or across multiple systems.

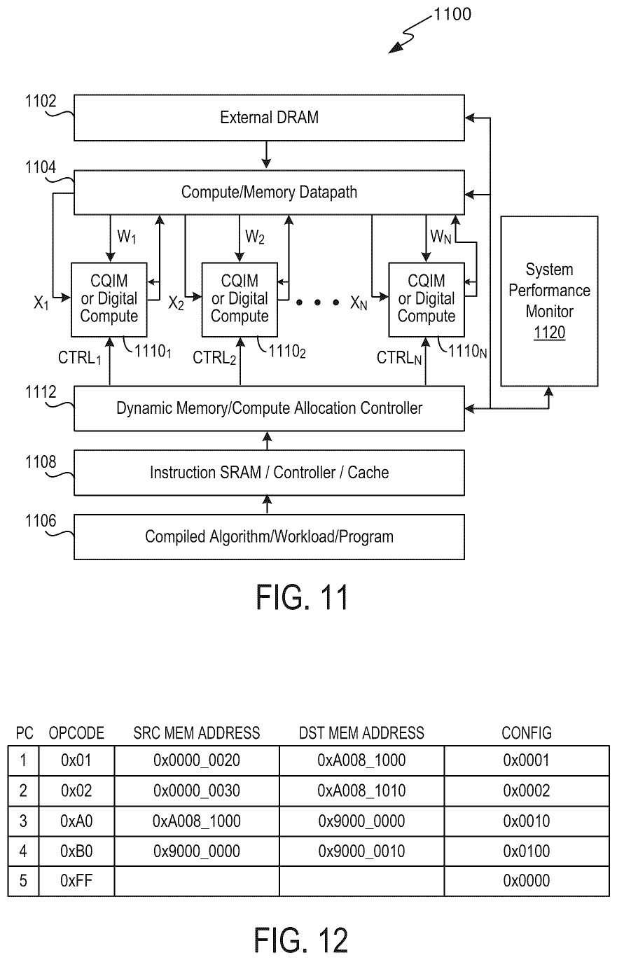

FIG. 11 shows a configurable compute fabric 1100, in accordance with one embodiment of the present disclosure. Compute fabric 1110 is shown as including, in part, a dynamic random access memory (DRAM) 1102, a compute/memory data-path logic block (alternatively referred to herein as data-path logic) 1104, a compiled algorithm/workload/program 1106, an instruction SRAM/controller/cache 1108, a dynamic memory/compute allocation controller (alternatively referred to hereinbelow as DMCA controller) 1112, and N compute modules, 1110₁, 1110₂ . . . 1110_{N} (collectively referred to herein as compute module 1110), and a system performance monitor 1120. Each compute module 1110ₖ, where k is integer varying from 1 to N in this example, maybe a CQIM tile as described above, for example, with reference to array 800 of FIG. 8, or may be a digital compute block. DMCA controller 1112 corresponds to machine learning agent 1110 shown in FIG. 10.

The CTRL signals applied to the compute modules 1110 is generated by controller 1112. The DMCA controller controls, among other elements, DRAM 1102, and compute modules/tiles 1110 through control signals CTRL₁, CTRL₂ . . . . CTRL_{N} that control, for example, in-memory addressing, ADC resolution, computation ordering, configurability to the computational accuracy or precision of compute fabric 1100, and the like. Signals W₁, W₂ . . . . W_{N} and X₁, X₂ . . . . X_{N} (X and W represent the data and weights that are multiplied by one another) supplied by data-path logic 1104 control, among other things, the width of data used by compute modules 1110, i.e., the bit depths. The compute modules 1110 may be unified into one memory addressing space of DRAM 1102, thus allowing for logical mapping of data onto the compute fabric 1100. Such mapping enables compute ordering to be optimized so that the compute fabric is fully utilized by computing in parallel, as well serially across the fabric as partial results are computed and available for the next stage or layer of computation. As shown in FIG. 11, each compute module 1110 may be formed using one or more CQIM tiles as shown in FIG. 8, or one or more digital compute blocks (we should show the components of a digital compute block), thereby allowing for flexibility in computation ordering, and for realizing more advanced mathematical operations or bitwise operations beyond multiply and accumulate.

In one embodiment, data-path logic 1104 is a configurable network-on-chip (such as network-on-chip 950 shown in FIG. 9) interface adapted to connect compute modules 1110₁ . . . 1110_{N} together. The data-path logic 1104 a may be a chip that conforms to any number of communication or networking protocols. External Memory 1102, which may be a DRAM, is also connected to data-path logic 1104 to provide access to data required by the compiled algorithm/workload/program 1106.

The DMCA controller 1112 is also shown as being connected to a system performance monitor 1120 that provides feedback to the DMCA controller about the compute fabric 1100's response to the ongoing computational operations. System performance monitor 1120 measures performance metrics such as throughput, latency, energy consumption or any other performance metrics. System performance monitor 1120 may be formed on the same die that includes the compute modules 1110. Alternatively, system performance monitor 1120 may be off-chip, or both on-chip and off-chip, and adapted to provide detailed metrics of performance at the SoC level or system level. DMCA controller 1112 is further configured to control DRAM 1102, or any other memory, internal or external, so as to optimally load the data used by the compiled algorithm/workload/program into the compute modules 1110 or other components of compute fabric 1100.

DMCA controller 1112 is further configured to control the flow of data between the compute modules 1100 by configuring the data path width between the compute modules and memory 1102. The DMCA controller is further configured to decode the instructions received from instruction cache 1108 and provide commands to the compute modules and other components of the compute fabric to execute the program. FIG. 12 is an example of the source and destination addresses in instructions cache 1108 that instructs DMCA controller 1112 how to command and configure the data path between the compute modules and memory 1102.

The control signals supplied by DMCA controller 1112 provide flexibility and optionality within the compute fabric 1100. These control signals configurate status and control registers within each compute module 1110. In embodiments where the compute modules 1110 are the CQIM tiles as shown in array 800 of FIG. 8, the control signals configure the bit resolution of the weights and inputs, the number of inputs included in the multiply and accumulation function, the output resolution of the SAR ADC, the reference voltage for the ADC, row configuration and merging, number of computations performed, and increase performance. Control signals that have more bits (i.e., are wider) may be used to control compute fabric's system level parameters, i.e. supply voltage, ambient temperature of the system, and other parameters.

Compiled algorithm/workload/program 1106 is loaded onto compute fabric 110 and stored in instruction cache. The instruction buffer is connected to and provide instructions to DMCA 1112 as shown in FIG. 11. The DMCA controller 1112 issues instructions and configuration signals to compute modules 1110 and memory 1102 for optimal computation.

In one embodiment, DMCA controller 1112 may be a machine learning agent (system), such as machine learning agent 1010 shown in FIG. 10, and trained on the algorithm and measurable metrics of the compute fabric 1100, such as throughput, latency, energy dissipation, and the like. As the machine learning system is trained, through reinforcement learning techniques, the machine learning system identifies the optimum configuration for the compute fabric 1100 to meet the performance metric that is identified as important during training. The training will also determine the optimal allocation of computation resources, memory allocation, and data-path traffic to meet the performance metrics.

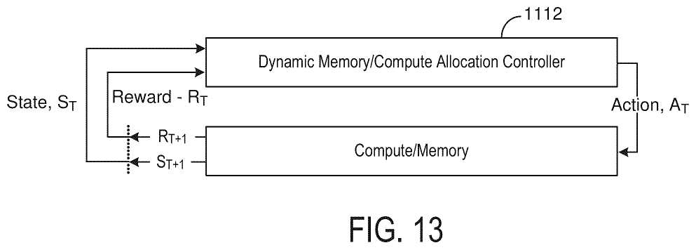

As an embodiment of the training, reinforcement learning techniques can be utilized to optimally determine the configuration of compute fabric 1100 to meet performance requirements. In one embodiment, such reinforcement learning may use the flow shown in FIG. 13. FIG. 13 shows DMCA controller 1112 being coupled to compute/memory block 1300. Compute/memory block 1300 includes, in part, compute modules 1110, data-path logic 1104, memory 1102 and instruction cache 1108 of compute fabric 1100. The state variables, S_{T}, S_{T+1} . . . supplied by compute/memory block 1300 include instructions and control signals supplied by, for example, compute modules 1110, data-path logic 1104, memory 1102 and instruction cache 1108 of compute fabric 1100. The state variable also represent modified values of the instructions shown in FIG. 12, defining the state of the system. The reward variables R_{T}, shown in FIG. 13, are generated by system performance monitor 1120 shown in FIG. 12. As DMCA 1112 configures the system during training, the metric, such as power, throughput, latency, etc., generates the reward signal so that the DMCA controller 1112 learns how to configure the state variable to maximize the reward variable R_{T}. The action variables, A_{T} are the signals that configure the compute/memory block 1300 so as to maximize the performance metric of interest of compute fabric 1100. At each iteration of the training step, variables S_{T} and R_{T} are updated to, for example, S_{T+1} and R_{T+1}, as shown in FIG. 13, according to the training algorithm driving the optimal action variable A_{T}.

The size of the training model depends on the size and number of computation modules, the memory, the width of the data path, and the like. The machine learning algorithm run on compute fabric 1100 may be hierarchical to reduce overall complexity and model size. Such hierarchical learning algorithms form a nested algorithm that may be executed in concert to enhance the overall control and efficiency of the compute fabric and its data path.

A trained model may then be deployed by the DMCA controller 1112, thereby enabling DMCA controller 1112 to make inferences about the optimal performance of the compute fabric 1100 and the algorithm/workload/program 1106 being run by the user. As instructions are being loaded from algorithm/workload/program 1106 into instruction cache 1108, the DMCA controller infers the optimum configuration based on the computation coded into the instruction. As the DMCA controller is aware of the entirety of the compute fabric 1100, scheduling of resource allocation, memory allocation, and data path control to avoid, for example congestion, is managed in accordance with the trained model.

FIG. 12 depicts an example of a compiled algorithm/workload/program 1106 of FIG. 11. The instruction shown contains 4 fields, an opcode, a source memory address, a destination memory address, and a configuration field. The opcode is a binary field, shown in hexadecimal, that indicates which function to execute. The source and destination fields provide the memory allocation controller the address to move data in to and out of the compute modules 1110. The configuration field provides the configuration of the compute modules 1110 being specified to execute the function identified in the opcode field.

For the compiled program shown in FIG. 12, the compute modules 1110 are assumed to be disposed along an array have 16 rows and 89 columns thus forming an 8 bit-wide configuration. The input data is also 8 bits wide. In the first instruction, identified as opcode of 0x0 and shown in the first row, the instruction causes the loading of the data into the memory address which stores the weights for the compute modules, resulting in a configuration for the weight data that is 8 bits wide. The second instruction, having the opcode 0x02 is similar to the first instruction but causes the input data to be loaded for the vector-dot-product operation. The third instruction, having the opcode 0xA0, initiates the vector-dot product operation for the compute modules 1110 and addressed at 0xA000_1000. The instruction further causes the results to be stored in address 0x9000_0000. The configuration for this instruction commands that the output be 8 bits in resolution. The fourth instruction, having the opcode 0xB0, is an example of a digital compute function, such as a scalar multiplication, on the data stored in the memory stored at the source address field, with the result of the operation being stored in the destination address field. The configuration command is provided to the digital compute block to select the function executed. the fifth instruction 0xFF indicates, for example, the program completion.

As seen from the above example the algorithm can be further optimized within the program's configuration. For example, the instructions shown in FIG. 12 could be optimized by configuration to achieve, for example, bit resolution, as the program is executed, or improve latency, and the like, without degrading the results of the algorithm.

Assume, for example, that the model is being trained to optimize latency. The trained model output would modify the compiled program, shown in FIG. 11 and FIG. 12 in the following ways. First, it can optimize the source and destination addresses to minimize the physical distance traveled. Because the latency is being optimized, the model is being trained to cause the compute fabric to an optimal point by selecting memory addressed that are physically close to one another, so as to minimize the latency.

The model may similarly be trained to adjust the configuration parameters to optimize the operation of compute fabric 1100. In the example shown in FIG. 12, and described above, the compute fabric is configures so as to provide a resolution of 8 bits. With a multiply and accumulate operation, the output resolution required for full output resolution is given by:

$$y = n + m + log 2 ( N )$$

where y is the output resolution, n and m are the weight and input resolutions respectively, and N is the number of weight and input pairs. When, for example, N=1, n=8, and m=8, the full output resolution is 16, but configured for 8 bit. Under such a condition, the trained model will adjust the first two instructions so as to load just the 4 MSBs of the weight and input data for the multiple and accumulate operation, as that is all this required to meet the output configuration of 8 bits. The result is an optimization of the latency performance parameter in conjunction with optimizing the addressing.

The foregoing Detailed Description signifies in isolation the individual features, structures, functions, or characteristics described herein and any combination of two or more such features, structures, functions or characteristics, to the extent that such features, structures, functions or characteristics or combinations thereof are based on the present specification as a whole in light of the knowledge of a person skilled in the art, irrespective of whether such features, structures, functions or characteristics, or combinations thereof, solve any problems disclosed herein, and without limitation to the scope of the claims. When an embodiment of a claimed invention comprises a particular feature, structure, function or characteristic, it is within the knowledge of a person skilled in the art to use such feature, structure, function, or characteristic in connection with other embodiments whether or not explicitly described, for example, as a substitute for another feature, structure, function or characteristic.

In view of the foregoing Detailed Description it will be evident to a person skilled in the art that many variations may be made within the scope of innovations, embodiments and/or examples, such as function and arrangement of elements, described herein without departing from the principles described herein. One or more elements of an embodiment may be substituted for one or more elements in another embodiment, as will be apparent to those skilled in the art. The embodiments described herein are chosen to signify the principles of the invention and its useful application, thereby enabling others skilled in the art to understand how various embodiments and variations are suited to the particular uses signified.

The foregoing Detailed Description of innovations, embodiments, and/or examples of the claimed inventions has been provided for the purposes of illustration and description. It is not intended to be exhaustive nor to limit the claimed inventions to the precise forms described, but is to be accorded the widest scope consistent with the principles and features disclosed herein. Many variations will be recognized by a person skilled in this art. Without limitation, any and all equivalents described, signified or incorporated by reference in this patent application are specifically incorporated by reference into the description herein of the innovations, embodiments and/or examples. In addition, any and all variations described, signified or incorporated by reference herein with respect to any one embodiment are also to be considered taught with respect to all other embodiments. Any such variations include both currently known variations as well as future variations, for example any element used herein includes a future equivalent element that provides the same function, regardless of the structure of the future equivalent.

What is claimed is:

1. A compute fabric comprising:
a plurality of compute tiles disposed in a memory block:
a networking circuit coupled to the plurality of compute tiles, the networking circuit adapted to enable communication between the plurality of compute tiles, and further to enable the plurality of compute tiles to communicate with a system external to the compute fabric; and
a controller configured to control the plurality of compute tiles, wherein each of the plurality of compute tiles comprises:
a plurality of multiplying bit-cells (MBC) disposed along M rows and N columns, where M an N are integers greater than one, wherein each MBC is configured to:
multiply a first bit by a second bit to generate a multiplication value;
convert the multiplication value to a charge; and
store the charge in a capacitor disposed in the MBC.

2. The compute fabric of claim 1 wherein the plurality of multiplying bit-cells are configured to multiply a first binary number by a second binary number, wherein the first bit is a bit disposed in a first binary number, and the second bit is a bit disposed in the second binary number.

3. The compute fabric of claim 1 wherein the controller is configured to control power usage associated with the plurality of multiplying bit-cells.

4. The compute fabric of claim 1 wherein the controller is configured to control a latency associated with the plurality of multiplying bit-cells.

5. The compute fabric of claim 1 wherein the controller is configured to control a throughput associated with the plurality of multiplying bit-cells.

6. The compute fabric of claim 1 wherein the controller is configured to control parallelization of the plurality of compute tiles.

7. The compute fabric of claim 1 wherein the controller is configured to control flow of data between the plurality of compute tiles and the networking circuit.

8. The compute fabric of claim 2 wherein each MBC comprises a circuit configured to perform a multiply-and-accumulate (MAC) operation, and a static random access memory cell.

9. The compute fabric of claim 8 wherein the first binary number is an input to the compute fabric and the second binary number is stored in the memory block.

10. The compute fabric of claim 9 wherein the controller is configured to control resolution of the plurality of compute tiles by dynamically programming number of clock cycles corresponding to which the first binary number is delivered to at least one of the plurality of compute tiles.

11. The compute fabric of claim 9 wherein the controller agent is configured to control resolution of the plurality of compute tiles by selecting number of memory cells that are used for the MAC operation.

12. The compute fabric of claim 9 wherein the controller is configured to control resolution of the plurality of compute tiles by programming number of steps performed in a binary search associated with a successive approximation register disposed in a compute tile.

13. The compute fabric of claim 1 wherein the compute fabric is further configured to:
receive a first set of input bits associated with a first matrix;
receive a second set of input bits associated with a second matrix;
distribute a first subset of the first input bits to a first group of the plurality of compute tiles;
distribute a second subset of the first input bits to a second group of the plurality of compute tiles;
distribute a first subset of the second input bits to a third group of the plurality of compute tiles;
distribute a second subset of the second input bits to a fourth group of the plurality of compute tiles;
instruct the first group of the plurality of compute tiles and the third group of the plurality of compute tiles to generate a matrix multiplication of the first subset of the first input bits by the first subset of the second input bit to generate a first partial summation;
instruct the second group of the plurality of compute tiles and the fourth group of the plurality of compute tiles to generate a matrix multiplication of the second subset of the first input bits by the second subset of the second input bit to generate a second partial summation; and
combine the first and second partial summation to generate result of the multiplication of the first matrix with the second matrix.

14. The compute fabric of claim 1 wherein the plurality of compute tiles are disposed along one or more rows.

15. The compute fabric of claim 1 wherein the plurality of compute tiles are disposed along one or more columns.

16. The compute fabric of claim 1 wherein the plurality of compute tiles are disposed along an array of one or more rows and one or more columns.

17. The compute fabric of claim 1 wherein the controller is configured to control a resolution of a successive approximation register (SAR) analog-to-digital converter (ADC) disposed in a compute tile.

18. The compute fabric of claim 17 where the controller is further configured to vary a reference voltage used by the ADC.

19. The compute fabric of claim 1 where the controller is further configured to vary number of computations performed by a compute tile.

20. The compute fabric of claim 1 further comprising a performance monitor, wherein the controller is trained to vary configuration of the compute fabric via reinforcement learning comprising:
setting a configuration state of the compute fabric to a first state;
measuring a performance characteristic of the compute fabric by the performance monitor;
receiving a reward signal in response to the measure performance characteristic; and
repeating the setting, the measuring and the receiving until the received reward reaches a maximum value.

21. The compute fabric of claim 20 wherein the performance characteristic comprises one or more of power usage, throughput, latency, and resolution.

22. The compute fabric of claim 20 wherein the configuration state of the compute fabric is defined by one or more of data path width between the compute tiles, number of bits of input data in which the first bit is disposed, resolution of a successive approximation register (SAR) analog-to-digital converter (ADC) associated with a compute tile, a reference voltage used by the ADC, and number of computations performed by a compute tile.

23. A method of computation comprising:
forming a plurality of compute tiles in a memory block:
enabling communication between the plurality of compute tiles and between the compute tiles and an external system;
controlling the plurality of compute tiles, wherein each of the plurality of compute tiles comprises:
a plurality of multiplying bit-cells (MBC) disposed along M rows and N columns, where M an N are integers greater than one, wherein each MBC is configured to:
multiply a first bit by a second bit to generate a multiplication value;
convert the multiplication value to a charge; and
store the charge in a capacitor disposed in the MBC.

24. The method of claim 23 wherein the plurality of multiplying bit-cells are configured to multiply a first binary number by a second binary number, wherein the first bit is a bit disposed in a first binary number, and the second bit is a bit disposed in the second binary number.

25. The method of claim 23 further comprising:
varying power usage associated with the plurality of multiplying bit-cells.

26. The method of claim 23 further comprising:
varying a latency associated with the plurality of multiplying bit-cells.

27. The method of claim 23 further comprising:
varying a throughput associated with the plurality of multiplying bit-cells.

28. The method of claim 23 further comprising:
varying parallelization of the plurality of compute tiles.

29. The method of claim 23 further comprising:
varying flow of data between the plurality of compute tiles.

30. The method of claim 24 wherein each MBC comprises a circuit configured to perform a multiply-and-accumulate (MAC) operation, and a static random access memory cell.

31. The method of claim 30 wherein the first binary number is an input to the compute fabric and the second binary number is stored in the memory block.

32. The method of claim 31 further comprising:
varying resolution of the plurality of compute tiles by dynamically programming number of clock cycles corresponding to which the first binary number is delivered to at least one of the plurality of compute tiles.

33. The method of claim 31 further comprising:
varying resolution of the plurality of compute tiles by selecting number of memory cells that are used for the MAC operation.

34. The method of claim 31 further comprising:
controlling resolution of the plurality of compute tiles by programming number of steps performed in a binary search associated with a successive approximation register disposed in a compute tile.

35. The method of claim 22 further comprising:
receiving a first set of input bits associated with a first matrix;
receiving a second set of input bits associated with a second matrix;
distributing a first subset of the first input bits to a first group of the plurality of compute tiles;
distributing a second subset of the first input bits to a second group of the plurality of compute tiles;
distributing a first subset of the second input bits to a third group of the plurality of compute tiles;
distributing a second subset of the second input bits to a fourth group of the plurality of compute tiles;
instructing the first group of the plurality of compute tiles and the third group of the plurality of compute tiles to generate a matrix multiplication of the first subset of the first input bits by the first subset of the second input bit to generate a first partial summation;
instructing the second group of the plurality of compute tiles and the fourth group of the plurality of compute tiles to generate a matrix multiplication of the second subset of the first input bits by the second subset of the second input bit to generate a second partial summation; and
combining the first and second partial summation to generate result of the multiplication of the first matrix with the second matrix.

36. The method of claim 22 wherein the plurality of compute tiles are disposed along one or more rows.

37. The method of claim 22 wherein the plurality of compute tiles are disposed along one or more columns.

38. The method of claim 22 wherein the plurality of compute tiles are disposed along an array of one or more rows and one or more columns.

39. The method of claim 22 wherein the controller is configured to control a resolution of a successive approximation register (SAR) analog-to-digital converter (ADC) disposed in a compute tile.

40. The method of claim 39 further comprising:
varying a reference voltage used by the ADC.

41. The method of claim 22 further comprising:
varying number of computations performed by a compute tile.

42. The method of claim 22 further comprising:
setting a configuration state of the compute fabric to a first state;
measuring a performance characteristic of the compute fabric;
receiving a reward signal in response to the measure performance; and
repeating the setting, the measuring and the receiving until the received reward reaches a maximum value.

43. The method of claim 42 wherein the performance characteristics comprises one or more of power usage, throughput, latency, and resolution.

44. The method of claim 22 wherein the configuration state is defined by one or more of data path width between the compute tiles, number of bits of input data in which the first bit is disposed, resolution of a successive approximation register (SAR) analog-to-digital converter (ADC) associated with a compute tile, a reference voltage used by the ADC, and number of computations performed by a compute tile.
